(19) United States
(12) Patent Application Publication
(10) Pub. No.: US 2023/0050113 A1
(43) Pub. Date: Feb. 16, 2023

(54) INDUSTRIAL INDICATOR LIGHT WITH STRAIGHT PLUG-IN WIRE ENTERING TECHNOLOGY

(71) Applicant: Phoenix Contact Asia-Pacific (Nanjing) Co., Ltd., Nanjing (CN)

(72) Inventors: Lei Chen, Nanjing (CN); Jinge Liu, Nanjing (CN)

(21) Appl. No.: 17/786,772

(22) PCT Filed: Dec. 14, 2020
(86) PCT No.: PCT/CN2020/136026

§ 371 Date: Jun. 17, 2022

(30) Foreign Application Priority Data
Dec. 24, 2019 (CN) 201911343831.8

(51) Int. Cl. H01R 13/717; H01R 13/42

(52) U.S. Cl. CPC H01R 13/717; H01R 13/42

(57) ABSTRACT

An industrial indicator light with straight plug-in wire entering technology may include a wiring module, a current bar, a wiring spring, a mounting shell and a push block, both the current bar and the wiring spring are clamped within the wiring module, the wiring module is to be inserted into the mounting shell, and the push block is to be located above the wiring spring and being capable of moving downward to press against the wire spring such that one end of the wire spring is spaced apart from the current bar. In the present example solution, straight plug-in wire entering is adopted to facilitate on-field wiring.

This application is a national stage application under 35 U.S.C. § 371 of International Application No. PCT/CN2020/136026, filed Dec. 14, 2020, which claims priority of Chinese Patent Application No. 201911343831.8, filed Dec. 24, 2019. The entire contents of each of Application Nos. PCT/CN2020/136026 and CN 201911343831.8 are incorporated herein by reference in their respective entireties.

### TECHNICAL FIELD

The present disclosure relates to an industrial indicator light with straight plug-in wire entering technology.

### BACKGROUND

Most of the industrial indicator lights on the market are screw-wiring type for wire entering. When wiring, one needs to loosen the screw first, enter the wire, and then tighten the screw. The operations are time-consuming and inconvenient. Therefore, it is indeed necessary to improve the existing technology to overcome the disadvantages thereof.

### SUMMARY

The present disclosure provides an industrial indicator light with straight plug-in wire entering technology. The disclosure solves the problem of time-consuming and labor-intensive wiring of the industrial indicator light. It does not require complicated operations, and wiring can be completed by a direct insertion into wire inlet, thereby solving the problem of time-consuming and labor-intensive on-field wiring of the industrial indicator light.

The solution adopted by the present disclosure comprises: an industrial indicator light with straight plug-in wire entering technology, comprising wiring module, current bar, wiring spring, mounting shell and push block, both the current bar and the wiring spring are clamped within the wiring module, the wiring module is to be inserted into the mounting shell, and the push block located above the wiring spring and being capable of moving downward to press against the wire spring such that one end of the wire spring is spaced apart from the current bar.

Further, the push block is provided with inverted buckle, and the wiring module is provided with a buckle boss to be mated with the inverted buckle.

Further, one end of the wiring spring is to be fixedly abutted against the current bar, and the other end of the wiring spring is to be movably abutted against the current bar.

Further, the current bar comprises U-shaped clamping portion and flat insertion portion which are integrally formed, one end of the wiring spring is to be fixedly abutted against one side wall of the U-shaped clamping portion, and the other end of the wiring spring is to be movably abutted against the other side wall of the U-shaped clamping portion.

Further, the upper end of the side wall of the U-shaped clamping portion, which is to be movably abutted against the wiring spring, protrudes to form a barb.

Further, the number of the wiring spring is four, the number of the current bar is two, and two wiring springs and a current bar constitute a group.

Further, the wiring module is provided with installation hole therein for installing the push block, and the buckle boss is formed on inner wall of the installation hole.

Further, the mounting shell is provided with wiring hole corresponding to the wiring spring.

Further, the mounting shell comprises an upper cover and a base, the wiring module is plugged onto the base, the wiring module is to be placed within the upper cover, the upper cover is to be buckled with the base, and the push blocks is to be inserted into the wiring module.

Further, two sockets are provided in the base, and the flat insertion portion of the current bar is plugged into the socket.

Further, an insertion stage is provided on the upper end face of the base, first socket slot (53) is provided on the insertion stage, a plug board to be mated with the first socket slot is provided on the wiring module, and second socket slot to be mated with the plug board is provided within the upper cover.

Further, insertion rib is provided on the outer wall of the wiring module, and a limiting slot that matches the insertion rib is provided in the inner wall of the upper cover.

Further, buckle is provided on the outer wall of the insertion stage, and a hole to be matched with the buckle is provided in the upper cover.

Further, the flat insertion portion of the current bar is provided with a mounting bent portion, the mounting bent portion is to be clamped onto the wiring module.

Further, the upper cover is provided with two test holes.

The present disclosure achieves the following beneficial effects:

1. The present disclosure adopts straight plug-in wire entrance, therefore it is convenient for on-field wiring; meanwhile, a test hole is provided, therefore it is convenient to detect whether the circuit is on or off during on-field wiring.

2. In the present disclosure, the wiring spring and the current bar are integrated with the wiring module as an entirety, and are easy to be assembled and disassembled.

### BRIEF DESCRIPTION OF DRAWINGS

FIG. 1 is a structural diagram of the present disclosure.

FIG. 2 is an exploded view of the present disclosure.

FIG. 3 is a diagram of the installation structure of the wiring module, the current bar and the wiring spring in the present disclosure.

FIG. 4 is a diagram of installation structure between the current bar and the wiring spring in the present disclosure.

FIG. 5 is a structural diagram of an external test probe of the present disclosure.

### DETAILED DESCRIPTION

The present disclosure will be further described below in conjunction with the accompanying figures.

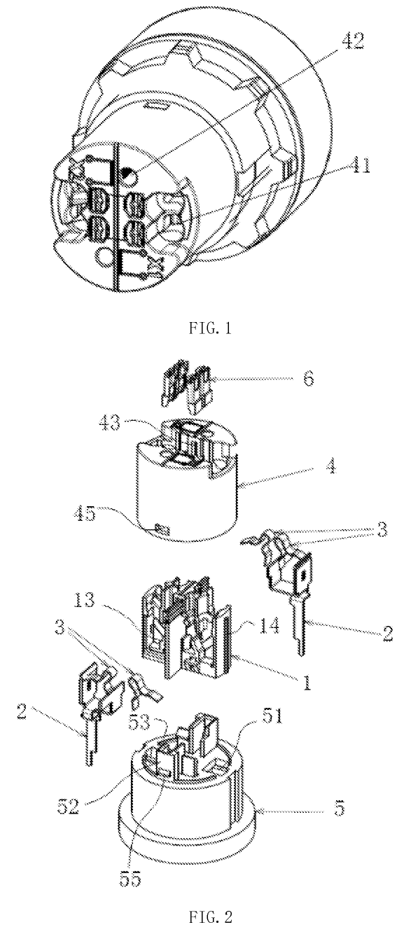

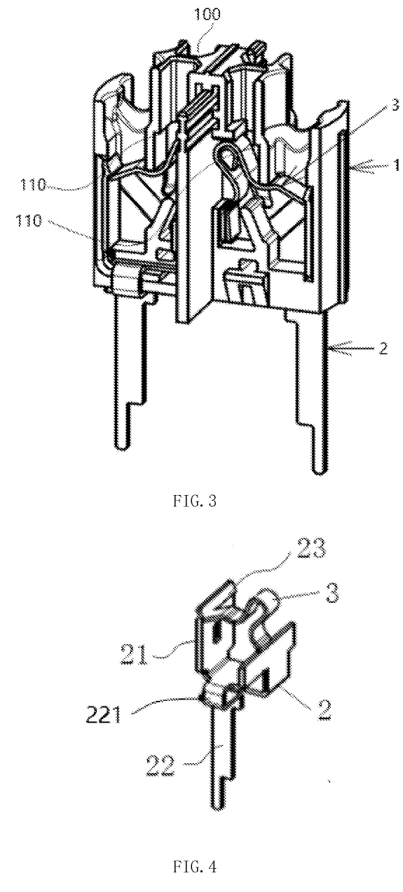

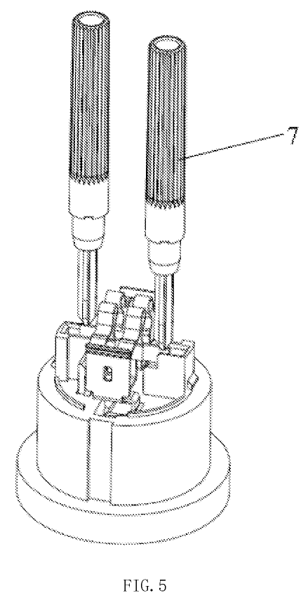

As shown in FIGS. 1 to 4, the industrial indicator light with straight plug-in wire entering technology of the present disclosure includes wiring module 1, current bar 2, wiring spring 3, mounting shell, and push block 6. Two current bars 2 and four wiring springs 3 are all clamped into the wiring module 1. Every two wiring springs 3 and one current bar 2 constitute a group, and the two ends of the two wiring springs 3 in each group are correspondingly abutted against the current bar 2, wherein one end is fixedly abutted against the current bar, and the other end of the wiring spring is movably abutted against the current bar. The wiring module 1 is inserted into the mounting shell. The mounting shell is provided with four wiring holes 41, with one wiring hole 41 corresponding to one wiring spring 3. The mounting shell includes an upper cover 4 and a base 5. The wiring module 1 is to be plugged onto the base 5, and the wiring module 1 is to be placed within the upper cover 4. The upper cover 4 is to be buckled with the base 5. Four push blocks 6 are inserted into the wiring module 1, and the four push blocks 6 are correspondingly buckled to the wiring module 1.

The current bar 2 in the present disclosure includes U-shaped clamping portion 21 and flat insertion portion 22, which are integrally formed. Two wiring springs 3 in each group are placed in the U-shaped clamping portion 21, wherein one end of the wiring spring 3 is fixedly abutted against one side wall of the U-shaped clamping portion 21, and the other end of the wiring spring 3 is movably abutted against the other side wall of the U-shaped clamping portion 21. The upper end of the side wall of the U-shaped clamping portion 21, which is to be movably abutted against the wiring spring 3, protrudes to form a barb 23.

Two sockets 51 are provided in the base 5. The flat insertion portion 22 of the current bar 2 is to be plugged into the socket 51.

In order to facilitate the connection and installation among the wiring module 1, the base 5 and the upper cover 4, an insertion stage 52 is provided on the upper end face of the base 5, a first socket slot 53 is provided on the insertion stage 52, a plug board 13 to be mated with the first socket slot 53 is provided on the wiring module 1, and a second socket slot 43 to be mated with the plug board 13 is provided within the upper cover 4.

In order to further ensure the reliability of the connection between the wiring module 1 and the upper cover 4, insertion rib 14 is provided on the outer wall of the wiring module 1, and limiting slot that matches the insertion rib 14 is provided in the inner wall of the upper cover 4.

Buckle 55 is provided on the outer wall of the insertion stage 52, and hole 45 to match the buckle 55 is provided in the upper cover 4.

Further, the flat insertion portion 22 of the current bar 2 is provided with a mounting bent portion 221. The mounting bent portion 221 is clamped onto the wiring module 1. Push block 6 is provided with inverted buckle 61. The wiring module 1 is provided with installation hole 100 therein for installing the push block 6. Inner wall of the installation hole 100 is provided with buckle boss 110 to be mated with the inverted buckle 61.

As shown in FIG. 5, the upper cover 4 in the present disclosure is provided with two test holes 42. Test probes 7 for conduction with the current bars 2 are to be respectively inserted into the two test holes 42. The two test probes 7 are to connect externally to a multimeter to detect whether the circuit is on or off during on-field wiring through the display of the multimeter.

When entering wire into the industrial indicator light with the straight plug-in wire entering technology of the present disclosure, each wire is to be inserted through the wiring hole 41 and clamped between the wiring spring 3 and the current bar 2, wherein the wire is provided with a clamping slot to match with the barb 23, so as to prevent the wire from being pulled out of the wiring hole 41, thereby completing the process of wire entrance and wiring. When wire exiting is needed, one only needs to manually press the push block 6, and the inverted buckle 61 of the push block 6 will press the wire spring 3 downward, so that the end of the wire spring 3 that is movably abutting against the current bar 2 is separated from the current bar 2. At this moment, the clamping slot of the wire will exit from the barb 23, and the wire can be pulled out from the wiring hole 41. After the push block 6 is released, the push block 6 moves upward, stops at the position limit of the buckle boss 110, and thus resets.

The above descriptions are only the preferred embodiments of the present disclosure. It should be pointed out that for those skilled in the art, several improvements can be made without departing from the principles of the present disclosure, and these improvements should also be regarded as the protection scope of the present disclosure.

1. An industrial indicator light with straight plug-in wire entering technology, the industrial indicator light comprising: a wiring module, a current bar, a wiring spring, a mounting shell and push block, wherein both the current bar and the wiring spring are clamped within the wiring module, the wiring module configured to be inserted into the mounting shell, and the push block configured to be located above the wiring spring and being configured to move downward to press against the wire spring such that one end of the wire spring is spaced apart from the current bar.

2. The industrial indicator light according to claim 1, wherein the push block comprises an inverted buckle, and the wiring module comprises a buckle boss configured to be mated with the inverted buckle.

3. The industrial indicator light according to claim 2, wherein one end of the wiring spring is configured to be fixedly abutted against the current bar, and the other end of the wiring spring is configured to be movably abutted against the current bar.

4. The industrial indicator light according to claim 3, wherein the current bar comprises a U-shaped clamping portion and flat insertion portion which are integrally formed, and wherein one end of the wiring spring is configured to be fixedly abutted against one side wall of the U-shaped clamping portion, and the other end of the wiring spring is configured to be movably abutted against the other side wall of the U-shaped clamping portion.

5. The industrial indicator light according to claim 4, wherein the upper end of the side wall of the U-shaped clamping portion, which is to be movably abutted against the wiring spring, protrudes to form a barb.

6. The industrial indicator light according to claim 3, wherein the number of the wiring spring is four, the number of the current bar is two, and two wiring springs and a current bar constitute a group.

7. The industrial indicator light according to claim 3, wherein the wiring module is provided with installation hole therein configured for installing the push block, and the buckle boss is formed on inner wall of the installation hole.

8. The industrial indicator light according to claim 3, wherein the mounting shell is provided with wiring hole corresponding to the wiring spring.

9. The industrial indicator light according to claim 4, wherein the mounting shell comprises an upper cover and a base, and wherein the wiring module is configured to be plugged onto the base, the wiring module is configured to be placed within the upper cover, the upper cover is configured to be buckled with the base, and the push blocks is configured to be inserted into the wiring module.

10. The industrial indicator light according to claim 9, wherein two sockets are provided in the base, and the flat insertion portion of the current bar is configured to be plugged into the socket.

11. The industrial indicator light according to claim 10, wherein an insertion stage is provided on the upper end face of the base, a first socket slot (53) is provided on the insertion stage, a plug board configured to be mated with the first socket slot is provided on the wiring module, and a second socket slot configured to be mated with the plug board is provided within the upper cover.

12. The industrial indicator light according to claim 11, wherein an insertion rib is provided on the outer wall of the wiring module, and a limiting slot that matches the insertion rib is provided in the inner wall of the upper cover.

13. The industrial indicator light according to claim 12, wherein a buckle is provided on the outer wall of the insertion stage, and a hole configured to be matched with the buckle is provided in the upper cover.

14. The industrial indicator light according to claim 4, wherein the flat insertion portion of the current bar is provided with a mounting bent portion, and wherein the mounting bent portion is configured to be clamped onto the wiring module.

15. The industrial indicator light according to claim 3, wherein the upper cover is provided with two test holes.
